(19) United States
(12) Patent Application Publication
(10) Pub. No.: US 2013/0048906 A1
(43) Pub. Date: Feb. 28, 2013

(54) IRON-CARBON COMPOSITIONS

(71) Applicants: Jason V. Shugart, Waverly, OH (US); Roger C. Scherer, Portsmouth, OH (US)

(72) Inventors: Jason V. Shugart, Waverly, OH (US); Roger C. Scherer, Portsmouth, OH (US)

(73) Assignee: THIRD MILLENNIUM METALS, LLC, Waverly, OH (US)

(21) Appl. No.: 13/599,668

(22) Filed: Aug. 30, 2012

Related U.S. Application Data
(60) Provisional application No. 61/528,845, filed on Aug. 30, 2011.

(51) Int. Cl. C01B 31/30; C09K 3/00

(52) U.S. Cl. 252/182.33; 423/439; 423/265

(57) ABSTRACT

An iron-carbon composition including iron chemically bonded to carbon, wherein the iron and the carbon form a single phase material, characterized in that the carbon does not phase separate from the iron when the single phase material is heated to a temperature that melts the iron-carbon composition.

### RELATED APPLICATIONS

This application claims the benefit of U.S. Provisional Application No. 61/528,845, filed Aug. 30, 2011.

### FIELD

The present application relates to compounds and/or compositions that include a metal and carbon that are formed into a single phase material and, more particularly, to iron-carbon compositions wherein the carbon does not phase separate from the iron when the resulting iron-carbon compositions are melted or re-melted.

### BACKGROUND

Pure iron is soft (softer than aluminum), but is unobtainable by smelting. Iron has a silvery grey appearance. The material is significantly hardened and strengthened by impurities from the smelting process, such as carbon. A certain proportion of carbon (between 0.2% and 2.1%) produces steel, an iron alloy, which may be up to 1000 times harder than pure iron. Crude iron metal is produced in blast furnaces, where ore is reduced by coke to cast iron. Further refinement with oxygen reduces the carbon content to make steel. Steels and low carbon iron alloys with other metals (alloy steels) are by far the most common metals in industrial use, due to their great range of desirable properties.

Iron also forms cementite, an iron carbide with the formula Fe₃C, typically found as a constituent of steel or cast iron. By weight, cementite is 6.67% carbon. It has an orthorhombic crystal structure and is a hard, brittle material, normally classified as a ceramic in its pure form. This compound, while having iron chemically bonded to carbon, has undesirable properties, in particular its brittleness. Bulk cementite has the formula (Fe_{0.95}Mn_{0.05})₇₅C₂₅, as reported in Materials Science Forum, Vol. 426-432 (2003) on pages 859-864 in an article by Umemoto et al., Mechanical Properties of Cementite and Fabrication of Artificial Pearlite.

### SUMMARY

A unique iron-carbon compound having physical and chemical properties notably different from iron carbide has been developed as disclosed herein. In one aspect, the iron and the carbon undergo an endothermic reaction by the application of an electric current and form a single phase material characterized in that the carbon does not phase separate from the iron when the resulting single phase material is heated to a temperature that melts the iron-carbon composition.

In another aspect, the iron-carbon composition may consist essentially of the iron and the carbon.

In another aspect, the iron-carbon composition is not cementite.

Other aspects of the disclosed iron-carbon composition will become apparent from the following description and the appended claims.

### DETAILED DESCRIPTION

Metal-based compounds and/or compositions that have carbon incorporated therein are disclosed. The compounds or compositions are a metal-carbon material that form a single phase material, and in such a way that the carbon does not phase separate from the resulting metal-carbon compound when the metal-carbon compound is melted. The metal herein is iron. Carbon can be incorporated into the iron by melting the iron, mixing the carbon into the molten iron and, while mixing, applying a current of sufficient amperage such that the carbon becomes incorporated into the iron, thereby forming a single phase metal-carbon material.

It is important that the current is applied while mixing the carbon into the molten iron. The current is preferably DC current, but is not necessarily limited thereto. The current may be applied intermittently in periodic or non-periodic increments. For example, the current may optionally be applied as one pulse per second, one pulse per two seconds, one pulse per three seconds, one pulse per four seconds, one pulse per five seconds, one pulse per six seconds, one pulse per seven seconds, one pulse per eight seconds, one pulse per nine seconds, one pulse per ten seconds and combinations or varying sequences thereof. Intermittent application of the current may be advantageous to preserve the life of the equipment and it can save on energy consumption costs.

The current may be provided using an arc welder. The arc welder should include an electrode that will not melt in the metal, such as a carbon electrode. In carrying out the method, it may be appropriate to electrically couple the container housing the molten metal to ground before applying the current. Alternately, the positive and negative electrodes can be placed generally within about 2 to 7 inches of one another, which increases the current density and as a result increases the bonding rate of the metal and carbon.

As used herein, the term “phase” means a distinct state of matter that is identical in chemical composition and physical state and is discernable by the naked eye or using basic microscopes (e.g., at most about 10,000 times magnification). Therefore, a material appearing as a single phase to the naked eye, but showing two distinct phases when viewed on the nano-scale should not be construed as having two phases.

As used herein, the phrase “single phase” means that the elements making up the material are bonded together such that the material is in one distinct phase.

While the exact chemical structure of the disclosed iron-carbon material is unknown, without being limited to any particular theory, it is currently believed that the steps of mixing and applying electrical energy result in the formation of chemical bonds between the iron and carbon atoms, thereby rendering the disclosed metal-carbon compositions unique vis-à-vis known metal-carbon composites and solutions of metal and carbon, i.e., the new material is not a mere mixture. The iron-carbon material is not an iron carbide.

Without being bound by theory, it is believed that the carbon is covalently bonded to the iron in the iron-carbon materials disclosed herein. The bonds may be single, double, and triple covalent bonds or combinations thereof, but it is believed, again without being bound by theory, that the bonds are most likely double or triple bonds. Accordingly, the covalent bonds formed between the iron and the carbon are not broken, i.e., the carbon does not separate from the metal, merely by melting the resulting single phase metal-carbon material or “re-melting” as described above. Furthermore, without being limited to any particular theory, it is believed that the disclosed iron-carbon material is a nanocomposite material and, as evidenced by the Examples herein, the amount of electrical energy (e.g., the current) applied to form the disclosed iron-carbon composition initiates an endothermic chemical reaction.

The disclosed iron-carbon material does not phase separate, after formation, when re-melted by heating the material to a melting temperature (i.e., a temperature at or above a temperature at which the resulting metal-carbon material begins to melt or becomes non-solid). Thus, the iron-carbon material is a single phase composition that is a stable composition of matter that does not phase separate upon subsequent re-melting. Furthermore, the iron-carbon material should remain intact as a vapor, as the same chemical composition, during magnetron sputtering tests.

The carbon in the disclosed metal-carbon compound may be obtained from any carbonaceous material capable of producing the disclosed metal-carbon composition. Non-limiting examples include high surface area carbons, such as activated carbons, and functionalized or compatibilized carbons (as familiar to the metal and plastics industries). A suitable non-limiting example of an activated carbon is a powdered activated carbon available under the trade name WPH®-M available from Calgon Carbon Corporation of Pittsburgh, Pa. Functionalized carbons may be those that include another metal or substance to increase the solubility or other property of the carbon relative to the metal the carbon is to be reacted with, as disclosed herein. In one aspect, the carbon may be functionalized with nickel, copper, iron, or silicon using known techniques.

The resulting iron-carbon compound described above is not in the form of a carbide. Furthermore, the carbon is not present as an organic polymer. Thus, the carbon is not a plastic, such as polyethylene, polypropylene, polystyrene, or the like.

The iron in the iron-carbon compound may be any iron or iron alloy capable of producing the disclosed iron-carbon compound. Those skilled in the art will appreciate that the selection of iron may be dictated by the intended application of the resulting iron-carbon compound. In one embodiment, the iron is 0.9999 iron. The iron alloy may be but is not limited to a steel or other ferroalloy having a range of percent by weight iron therein. In one embodiment, the iron alloy is a grey iron, commonly referred to as cast iron. In the embodiment described in Example 2 below the grey iron was from class 25—ASTM E 1999-99 and included about 3.5% carbon, about 2% silicon and about 0.5 to 0.8% manganese. The grey iron may be from any class per the ASTM standards.

In another aspect, the single phase metal-carbon material may be included in a composition or may be considered a composition because of the presence of other impurities or other alloying elements present in the metal and/or metal alloy.

Similar to metal matrix composites, which include at least two constituent parts—one being a metal, the iron-carbon compositions disclosed herein may be used to form iron-carbon matrix composites. The second constituent part in the iron-carbon matrix composite may be a different metal or another material, such as but not limited to a ceramic, glass, carbon flake, fiber, mat, or other form. The iron-carbon matrix composites may be manufactured or formed using known and similarly adapted techniques to those for metal matrix composites.

In one aspect, the disclosed iron-carbon compound or composition may comprise at least about 0.01 percent by weight carbon. In another aspect, the disclosed iron-carbon compound or composition may comprise at least about 0.1 percent by weight carbon. In another aspect, the disclosed iron-carbon compound composition may comprise at least about 1 percent by weight carbon. In another aspect, the disclosed iron-carbon compound or composition may comprise at least about 5 percent by weight carbon. In another aspect, the disclosed iron-carbon compound or composition may comprise at least about 10 percent by weight carbon. In yet another aspect, the disclosed iron-carbon compound or composition may comprise at least about 20 percent by weight carbon.

In another aspect, the disclosed iron-carbon compound or composition may comprise a maximum of 1%, 5%, 10%, 15%, 20%, 25%, 30%, 35%, or 40% by weight carbon. In one embodiment, the iron-carbon compound or composition may have the maximum percent by weight carbon customized to provide particular properties thereto.

The percent by weight carbon present in the compound or composition may change the thermal conductivity, ductility, electrical conductivity, corrosion resistance, oxidation, formability, strength performance, and/or other physical or chemical properties. In the iron-carbon compound or composition, it has been determined that increased carbon content increases toughness, wear resistance, thermal conductivity, strength, ductility, elongation, corrosion resistance, and energy density capacity and decreases coefficient of thermal expansion and surface resistance. Accordingly, the customization of the physical and chemical properties of the iron-carbon compounds or compositions can be tailored or balanced to targeted properties through careful research and analysis.

The formation of the iron-carbon composition may result in a material having at least one significantly different property than the iron itself. For example, the iron-carbon composition has significantly enhanced thermal conductivity with a significantly reduced grain structure when compared to standard iron.

In one embodiment, the carbon is present in the iron-carbon material as about 0.01 to about 40 percent by weight of the composition. In another embodiment, the carbon is present in the iron-carbon material as about 1 to about 70 percent by weight of the composition.

Accordingly, the disclosed metal-carbon compositions may be formed by combining certain carbonaceous materials with the selected metal to form a single phase material, wherein the carbon from the carbonaceous material does not phase separate from the resulting metal-carbon compound when the single phase material is cooled and subsequently re-melted. The metal-carbon compositions may be used in numerous applications as a replacement for more traditional metals or metal alloys and/or plastics and in hereinafter developed technologies and applications.

### EXAMPLE 1

An open air reaction vessel was charged with 3 pounds (1.36 kg) of 0.9999 iron, with 7.3 pounds (3.31 kg) set aside for later addition. A carbon (graphite) electrode affixed to an arc welder was positioned in the reaction vessel. The arc welder was a Pro-Mig 135 arc welder obtained from The Lincoln Electric Company of Cleveland, Ohio. With the arc welder set at 26.5 amps, the 3 pounds of iron was heated to a temperature of 2650° F., which converted the iron to its molten state. Once the initial 3 pounds of iron was melted, the remaining 7.3 pounds was added and melted. The arc welder was increased to 40.5 amps until all the iron was melted. Once melted and prior to adding carbon, the arc welder's current was reduced to 35.5 amps.

An agitator end of a rotary mixer was inserted into the molten iron and the rotary mixer was actuated to form a vortex. While mixing with the mixer set at about 1305 rpm, about 3% by weight of the resulting compound was added in grams of carbon, i.e., about 140.3 g carbon. The carbon was powdered activated carbon. The carbon was introduced into the vortex of the molten iron using a custom built feeding unit. The powdered activated carbon used was WPH®-M powdered activated carbon, available from Calgon Carbon Corporation of Pittsburgh, Pa. The carbon feed unit was set to introduce an amount of carbon per minute such that the entire amount of carbon was introduced in about 12 to 15 minutes.

Throughout the period the powdered activated carbon is introduced into the molten iron, and while continuing to mix the carbon into the molten iron, the arc welder was intermittently actuated to supply direct current at 378 amps through the molten iron and carbon mixture. The application of current to the mixture continues after the carbon addition is completed in order to complete the conversion of the iron and carbon to the new iron-carbon material.

Two plates of iron-carbon material were poured after application of the direct current. One plate, a two inch by eight inch plate, was preheated to 700° F. and the other plate, a three inch by six inch plate, was left at room temperature. Any slag that was formed during the process went to the top of the molten material. To transfer the resulting iron-carbon compound from the reaction vessel to the plates, the arc welder had to be turned off because, while on, the iron was magnetically attracted to the vessel and would not pour into the plates.

To determine the actual amount of carbon added to the iron, the amount of carbon remaining in the feeder was determined and was subtracted from the initial amount of carbon placed in the feeder. This calculation indicated that 122.3 grams of carbon was added to the iron for an iron-carbon compound that comprises about 2.7% carbon by weight of the compound.

After cooling, the iron-carbon compound was observed by the naked eye to exist in a single phase. The material was noted to have cooled rapidly. The cooled iron-carbon composition was then re-melted by heating to a few hundred degrees Fahrenheit above a temperature at which the iron-carbon compound melts and was poured into molds. No phase separation was observed of the carbon relative to the iron.

### EXAMPLE 2

A batch of grey iron (class 25—ASTM E 1999-99) was obtained and melted by traditional heating methods without the application of any form of electric current to divide the grey iron into a plurality of samples by pouring the molten grey iron into billet molds and once cooled, weighing about 15.5 pounds.

Billet 1 was then re-melted using an arc welder, similarly to that in Example 1, with the application of alternating current. It took approximately 18 minutes to melt and had a temperature of about 2610° F. Once the grey iron was molten, the arc welder was switched to DC current at about 378 amps. While applying the DC current the molten grey iron with rapid mixing creating a vortex therein. After twenty minutes of mixing the carbon into the metal while applying the current, the reaction was complete and two 2-inch billets were poured and set aside to harden.

It was observed that the carbon impeller used for the mixing and the carbon electrodes of the arc welder experienced weight loss. The impeller was weighed and had a weight loss of 70 grams. This 70 grams was equivalent to an addition of about 1% carbon to the grey iron. The electrodes loss was not calculated, but would have added additional carbon.

Billet 2 was also re-melted using an arc welder with the application of alternating current. It took approximately 19 minutes to melt and had a temperature of about 2340° F. Once the grey iron was molten, DC current at about 378 amps was applied thereto. While applying the DC current 230 grams of powdered carbon was added slowly into the molten grey iron with rapid mixing that created a vortex within the molten metal. After twenty minutes of slowly adding the carbon with mixing, the reaction was complete and two 2-inch billets were poured and set aside to harden.

Some carbon was unreacted, which was evident because it was floating on the surface of the molten metal. The carbon impeller's mass was reduced by 95% and there again was weight loss to the carbon electrode of the arc welder. It is estimated that the impeller and electrodes contributed as much as about 3% carbon to the grey iron in addition to the carbon powder that reacted. If all 230 g of powdered carbon had reaction about 3% carbon would have been added to the grey iron. Thus, at least about 3% carbon was added, but the total could be higher as well.

Furthermore, testing showed that the iron-carbon compound had improved thermal conductivity, and fracture toughness, significantly reduced grain structure, and numerous other property and processing enhancements not found in traditional iron.

What is claimed is:

1. An iron-carbon composition comprising:
iron chemically bonded to carbon, wherein the iron and the carbon form a single phase material formed by mixing carbon into the iron while molten under conditions that chemically react the iron and the carbon, wherein the single phase material is meltable and the carbon does not phase separate from the iron when the single phase material is subsequently re-melted.

2. The iron-carbon composition of claim 1 wherein the iron is an iron alloy.

3. The iron-carbon composition of claim 1 wherein the iron is grey iron.

4. The iron-carbon composition of claim 1 wherein the carbon comprises about 0.01 to about 40 percent by weight of the material.

5. The iron-carbon composition of claim 1 wherein the carbon comprises at least about 1 percent by weight of the material.

6. The iron-carbon composition of claim 1 wherein the carbon comprises at least about 5 percent by weight of the material.

7. The iron-carbon composition of claim 1 wherein the carbon comprises at most about 10 percent by weight of the material.

8. The iron-carbon composition of claim 1 wherein the carbon comprises at most about 25 percent by weight of the material.

9. The iron-carbon composition of claim 1 further comprising an additive that imparts a change to a physical or mechanical property of the composition.

10. An iron-carbon composition consisting essentially of:
iron chemically bonded to carbon, wherein the iron and carbon form a single phase material, and wherein the carbon does not phase separate from the iron when the single phase material is heated to a temperature that melts the iron-carbon composition.

11. The iron-carbon composition of claim 10 wherein the iron is an iron alloy.

12. The iron-carbon composition of claim 10 wherein the iron is grey iron.

13. The iron-carbon composition of claim 10 wherein the carbon comprises about 0.01 to about 40 percent by weight of the material.

14. The iron-carbon composition of claim 10 wherein the carbon comprises at least about 1 percent by weight of the material.

15. The iron-carbon composition of claim 10 wherein the carbon comprises at least about 5 percent by weight of the material.

16. The iron-carbon composition of claim 10 wherein the carbon comprises at most about 10 percent by weight of the material.

17. The iron-carbon composition of claim 10 wherein the carbon comprises at most about 25 percent by weight of the material.
